(19) United States
(12) Patent Application Publication
(10) Pub. No.: US 2024/0022096 A1
(43) Pub. Date: Jan. 18, 2024

(54) Adapter for an Exchangeable Rechargeable Battery Pack

(71) Applicant: Robert Bosch GmbH, Stuttgart (DE)

(72) Inventor: Bernhard Hegemann, Filderstadt (DE)

(21) Appl. No.: 18/254,712

(22) PCT Filed: Dec. 13, 2021
(86) PCT No.: PCT/EP2021/085409

§ 371 Date: May 26, 2023

(30) Foreign Application Priority Data
Dec. 18, 2020 (DE) 10 2020 216 263.8

(51) Int. Cl. H02J 7/00; H02J 50/10; H01R 31/06

(52) U.S. Cl. CPC H02J 7/0045; H02J 50/10; H01R 31/065

(57) ABSTRACT

An adapter for an exchangeable rechargeable battery pack of an electric device or for a charging device is suitable for charging the exchangeable rechargeable battery pack. In order to transmit energy, the adapter has an electromechanical interface with electric contacts, via which the adapter can be releasably connected to an electromechanical interface of the exchangeable rechargeable battery pack or of the charging device. The adapter has a wireless interface for transmitting energy provided by the exchangeable rechargeable battery pack or by the charging device to a wireless energy receiver.

The invention relates to an adapter for an exchangeable rechargeable battery pack of a battery-powered electric device or for a charging device which is suitable for charging the exchangeable rechargeable battery pack of the type specified in independent claim 1.

### THE PRIOR ART

It is known from US 2014/0117922 A1 to use an exchangeable rechargeable battery pack for a battery-powered hand tool using a plug-in adapter in order to charge the battery of a mobile telecommunication device. For this purpose, the mobile telecommunication device is connected to the adapter attached to the exchangeable re-chargeable battery pack plugged in via USB cable.

It is also known to wirelessly charge battery-powered hand tools such as toothbrushes, cellular devices, electrically-powered hand tools, and the like. To this end, an electromagnetic field is used for inductive energy transmission from a primary coil, e.g. a charging device, to a secondary coil, e.g. a smartphone, which are positioned at a short distance from one another and in this way substantially form a transformer. Exchangeable rechargeable battery packs for electrical tools or other battery-powered electric devices can also be inductively charged in a similar manner.

Proceeding from the prior art, the problem addressed by the invention is to use a commercially available exchangeable rechargeable battery pack for a battery-powered electric device as an energy source for convenient, wireless charging of an energy receiver, in particular a mobile or wearable device.

### Advantages of the Invention

The invention relates to an adapter for an exchangeable rechargeable battery pack of a battery powered electric device or for a charging device which is suitable for charging the exchangeable rechargeable battery pack. The adapter has an electromechanical interface with electric contacts for energy transmission, via which it can be releasably connected to an electromechanical interface of the exchangeable rechargeable battery pack or the charging device. To solve the problem posed, the adapter has a wireless interface for transmitting energy provided via the exchangeable rechargeable battery pack or via the charging device to an energy receiver. Particularly advantageously, a commercially available exchangeable rechargeable battery pack can be used for wireless charging, e.g., of a smartphone or a wearable. This is particularly helpful in situations where there are no other energy sources available for charging a discharged energy receiver designed as a smartphone, wearable device, or the like.

In the context of the invention, a battery-powered electric device is understood to mean an electrical tool in particular. The power tool can in this case be designed both as a hand-held power tool, or also as a stationary electrical machine tool. Typical power tools in this context include hand or bench drills, screwdrivers, percussion drills, hammer drills, planers, angle grinders, orbital sanders, polishing machines, circular saws, table saws, crosscut saws, and jigsaws, or the like. However, measuring devices such as distance meters, laser leveling aids, etc., or outdoor equipment such as lawnmowers, lawn trimmers, branch saws, or the like also represent potential battery-powered electrical devices. Furthermore, the invention is also useful in connection with exchangeable rechargeable battery packs for battery-powered household devices, e.g., vacuum cleaners, mixers, etc., or for e-bikes, e-scooters, etc.

In particular, a wireless energy receiver in the context of the invention is intended to mean a wirelessly chargeable cellular device or a correspondingly chargeable wearable device, e.g., a smart watch, a fitness band, smart glasses, or other battery-powered devices that are wearable on the body of an operator.

Devices typically operated using exchangeable rechargeable battery packs are available in a wide variety of power classes, depending on their intended use. There are, e.g., hand-held power tools and garden and household tools in lower power classes that are operated at 10.8 V (conventionally often also referred to as 12 V) or 14.4 V, whereas, in the medium to higher power classes, electrical devices in the voltage classes of 18 V, 36 V, 54 V, or also 72 V are predominantly used. In this context, the voltage values result from the connection (parallel or series) of the battery cells being used in the exchangeable rechargeable battery pack. The battery cells are in this case preferably designed as lithium-based battery cells, e.g., Li-Ion, Li—Po, Li-metal or the like, with a cell voltage of 3.6 V, in which case a battery cell is typically a cylindrical round cell, whose cell poles are arranged at ends of the cylindrical shape. However, the following invention does not depend on the type, design, and number of the battery cells, but can be used for any desired exchangeable rechargeable battery pack.

Via correspondingly designed electromechanical interfaces having a plurality of electric contacts, the exchangeable rechargeable battery pack can be releasably connected to the battery-powered electric device or the adapter according to the invention in a frictional and/or interlocking manner. In this context, the term “releasable connection” is in particular understood to mean a connection that can be released and established without using a tool, i.e., manually. It should also be noted that the design of the electromechanical interfaces of the adapter, the exchangeable rechargeable battery pack, the battery-powered electric device, and the charging device according to the invention, as well as the associated receptacles used in the releasable frictional and/or interlocking connection for the various voltage classes, are not intended to be the subject matter of this invention. The electromechanical interfaces of the exchangeable rechargeable battery packs of a voltage class are typically designed such that they are only compatible with the corresponding interfaces of battery-powered electric devices in the same voltage or power class. The same is accordingly true of the adapter according to the invention. A skilled person will select a suitable embodiment for the interfaces depending on the energy or voltage class of the battery-powered electric device, the exchangeable rechargeable battery pack, and/or the adapter according to the invention. The embodiments disclosed in the exemplary embodiments should therefore be understood merely by way of example.

Particularly advantageously, the wireless interface comprises a primary coil for inductively transmitting energy to a secondary coil of the energy receiver. Given that inductive energy transmission, among other wireless energy transmission forms (e.g., optical or by movement), is used the most frequently, the result is a maximum possible compatibility of the adapter according to the invention using correspondingly equipped energy receivers, in particular when the wireless interface operates according to the widely used Qi standard for transmission capacities of up to 5 watts (baseline power profile) or 15 watts (extended power profile) at transmission frequencies of between 87 and 205 kHz and data rates of up to 2 kBit/s.

For as simple a connection as possible of the energy receiver to the adapter, the wireless interface is arranged on a side of the adapter substantially opposite the electromechanical interface. In other words, when the electromechanical interface is on a bottom side of the adapter, the wireless interface is arranged on its top side. The bottom and top sides do not in this case necessarily have to extend parallel to one another, but can also be at an angle of up to 30°. This is particularly advantageous when the electromechanical interface of the exchangeable rechargeable battery pack or charging device does not extend in a direction perpendicular to gravity. It is likewise conceivable that the wireless interface of the adapter be adjustable in terms of its angle to the electromechanical interface by the operator.

In order to be able to charge an exchangeable rechargeable battery pack connected to the mechanical interface of the adapter via the wireless interface, energy can also be transmitted in the opposite direction from the wireless interface to the electromechanical interface. In this case, instead of a wireless energy receiver, a wirelessly operating charging device is of course used as the energy source.

In order for the adapter to be securely connected to the exchangeable rechargeable battery pack, the electromechanical interface of the adapter comprises a receptacle for locking with a locking device of the exchangeable rechargeable battery pack.

Particularly advantageously, a height extension of the adapter is less than twice the height extension of the electromechanical interface. A particularly compact and stowable adapter design can be provided in this way.

A further embodiment of the invention provides that the adapter comprises an indicator for signaling the energy transport and/or a direction of the energy transport. As a result, an operator can immediately detect whether energy is being transmitted and, optionally, which of the two charging partners is functioning as an energy source and which one is functioning as an energy receiver.

In addition to the electromechanical interface for the exchangeable rechargeable battery pack, or rather for a charging device suitable for charging the exchangeable rechargeable battery pack, as well as in addition to the wireless interface, the adapter can have a further electromechanical interface, in particular a USB socket, for discharging and/or charging the exchangeable rechargeable battery pack connected thereto.

### EXEMPLARY EMBODIMENTS

### Drawings

The invention is explained hereinafter with reference to FIGS. 1 and 2 by way of example, whereby identical reference characters in the drawings indicate identical components having an identical function.

Shown are:

FIG. 1: a schematic illustration of a system consisting of an exchangeable rechargeable battery pack for various battery-powered electric devices, as well as a charging device for charging the exchangeable rechargeable battery pack, and

FIG. 2: a schematic illustration of the adapter according to the invention for the exchangeable rechargeable battery pack.

### DESCRIPTION OF THE EXEMPLARY EMBODIMENTS

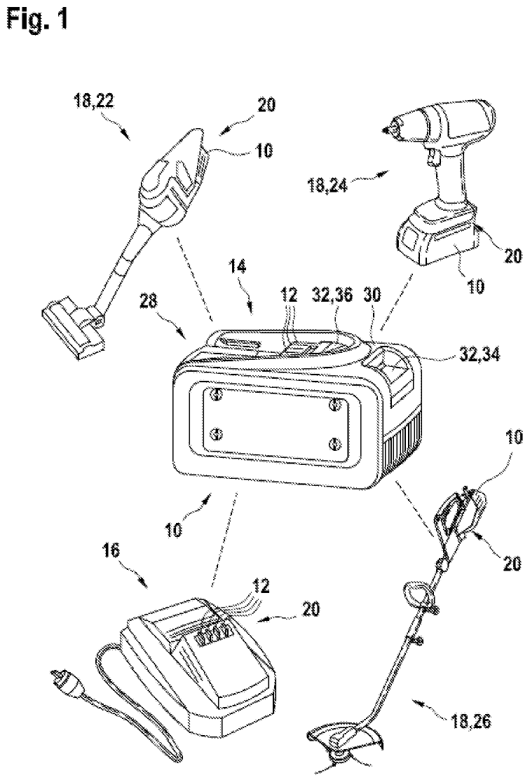

FIG. 1 shows an exchangeable rechargeable battery pack 10 with an electromechanical interface 14 having a plurality of electric contacts 12. The exchangeable rechargeable battery pack 10 can be charged by means of a charging device 16 and discharged by various battery-powered electric devices 18. To this end, the charging device 16 and the battery-powered electric devices 18 each comprise a further electromechanical interface 20 having a plurality of electric contacts 12. FIG. 1 is intended to illustrate that the exchangeable rechargeable battery pack 10 is suitable for various battery-powered electric devices 18. By way of example, a battery vacuum cleaner 22, a battery impact wrench 24, and a battery lawn trimmer 26 are shown. However, the type of battery-powered electric device 18 does not play any role in the context of the invention. As such, a variety of power tools, outdoor implements, domestic implements, and vehicles represent potential battery-powered electric devices 18.

The exchangeable rechargeable battery pack 10 comprises a housing 28, a side wall or top side 30 of which comprises the electromechanical interface 14 for detachable connection with the further electromechanical interface 20 of the charging device 16 or the battery-powered electric device 18. In connection with the battery-powered electric device 18, the electromechanical interfaces 14, 20 are primarily used to discharge the exchangeable rechargeable battery pack 10, while, in connection with the charging device 16, they are used in order to charge the exchangeable rechargeable battery pack 10. The exact design of the electromechanical interfaces 14, 20 depends on various factors, such as the voltage class of the exchangeable rechargeable battery pack 10, or of the battery-powered electric device 18, and various manufacturer specifications. For example, it is also possible to provide three or more electric contacts 12 for energy and/or data transmission between the exchangeable rechargeable battery pack 10 and the charging device 16 or the battery-powered electric device 18. Mechanical coding is also conceivable, so that the exchangeable rechargeable battery pack 10 can be operated only on specific battery-powered electric devices 18. Given that the mechanical design of the electromechanical interface 14 of the exchangeable rechargeable battery pack 10 and of the further electromechanical interface 20 of the charging device 16 or the battery-powered electric device 18 is irrelevant to the invention, it will not be discussed in further detail. Both a skilled person and a user of the exchangeable rechargeable battery pack 10 and the charging device 16, or rather the battery-powered electric device 18, will make the appropriate selection in this respect.

The exchangeable rechargeable battery pack 10 comprises a mechanical locking device 32 for securing the detachable frictional and/or interlocking connection between the electromechanical interface 14 of the exchangeable rechargeable batter pack 10 and the corresponding counter-interface 20 (not shown in detail) of the battery-powered electric device 18. The locking device 32 is in this case designed as a spring-loaded push button 34 that is operatively connected to a locking element 36 of the exchangeable rechargeable battery pack 10. Given the resilience of the push button 34 and/or of the locking element 36, the locking device 32 automatically engages into a corresponding receptacle upon insertion of the exchangeable rechargeable battery pack 10 into the counter-interface 20 of the battery-powered electric device 18. If a user presses the push button 34 in the insertion direction, the locking is released and the user can remove or extend the exchangeable rechargeable battery pack 10 from the battery-powered electric device 18 in the direction opposite the insertion direction. Typically, the charging device 16 does not have a corresponding receptacle in the electromechanical interface 20 for locking the exchangeable rechargeable battery pack 10 in order to enable the exchangeable rechargeable battery pack 10 to be quickly inserted and removed. Nevertheless, a corresponding locking option for the exchangeable rechargeable battery pack (e.g., for safe charging during a car drive or the like) can also be provided in the charging device 16.

As previously mentioned hereinabove, the battery voltage of the exchangeable rechargeable battery pack 10 generally results from a multiple of the individual voltages of the energy store cells (not shown) as a function of their connection (in parallel or in series). The energy store cells are preferably designed as lithium-based energy store cells, e.g., Li-ion, Li—Po, Li-metal, or the like. However, the invention is also applicable to exchangeable rechargeable battery packs with Ni—Cd, Ni—MH cells, or other suitable cell types.

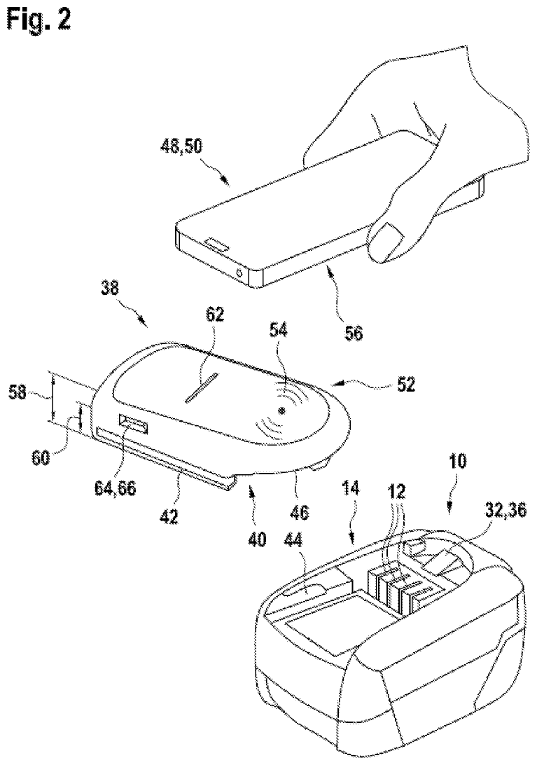

FIG. 2 shows the adapter 38 according to the invention for use with the exchangeable rechargeable battery pack 10 according to FIG. 1. The adapter comprises a corresponding electromechanical interface 40 for the detachable frictional and/or interlocking connection between the adapter 38 and the electric contacts 12 comprising the electromechanical interface 14 of the exchangeable rechargeable battery pack 10, which interface substantially corresponds to the electromechanical interfaces 20 of the charging device 16 and the battery-powered electric device 18. The electromechanical interface 40 of the adapter 38 therefore also comprises a plurality of electric contacts 12 for energy transport and optionally data transmission from and/or to the exchangeable rechargeable battery pack 10. In addition, guide grooves 42 are provided on the electromechanical interface 40 of the adapter 38 in the inward and outward directions, into which the corresponding guide projections 44 of the electromechanical interface 14 of the exchangeable rechargeable battery pack 10 engage. In order to be able to lock the adapter 38 onto the exchangeable rechargeable battery pack 10, a receptacle 44 is provided in the electromechanical interface 40 of the adapter 38, into which the locking member 36 of the locking device 32 of the exchangeable rechargeable battery pack 10 can engage in the inserted state of the adapter 38. If the operator pushes the pusher 34 of the exchangeable rechargeable battery pack 10 counter to the insertion direction of the adapter 38, the lock is released and the operator can remove the adapter 38 from the exchangeable rechargeable battery pack 10.

In order to wirelessly charge an energy receiver 48, e.g. a smartphone 50, using the adapter 38, the adapter comprises a wireless interface 52 for transmitting the energy provided by the exchangeable rechargeable battery pack 10 or by the charging device 16 to the energy receiver 48. For this purpose, the adapter 38 must be connected to the electromechanical interface 20 of the exchangeable rechargeable battery pack 10 via its electromechanical interface 40 in the manner described hereinabove so that energy transport can take place via the electric contacts 12.

For inductive energy transmission, the wireless interface 52 has a primary coil 54 (indicated in FIG. 2 by an inductive charging symbol), which cooperates in a known manner with a secondary coil 56 of the energy receiver 48. Given that the inductive energy transmission according to the Qi standard in particular is known to the skilled person, it will not be discussed in detail. In addition to the inductive energy transmission, however, other wireless energy transmission forms, e.g. optical or by movement, are also possible. However, the Qi standard represents the most common wireless energy transmission method for mobile battery-powered devices like smartphones or wearables. Transmission capacities of up to 5 watts (baseline power profile) or 15 watts (extended power profile) at transmission frequencies of between 87 and 205 kHz and data rates of up to 2 kBit/s are thereby possible.

For as simple a connection as possible of the energy receiver 48 to the adapter 38, the wireless interface 52 is arranged on a side of the adapter 38 substantially opposite the electromechanical interface 40. In the exemplary embodiment shown, the electromechanical interface 40 is arranged on a bottom side of the adapter 38, while the wireless interface 52 is arranged on its top side. As a result, the operator can simply place the energy receiver 48 onto the adapter 38 inserted into the exchangeable rechargeable battery pack 10 for charging. The bottom and top sides of the adapter 10 do not necessarily have to extend parallel to one another, but can also be at an angle of up to 30°. This is particularly advantageous when the electromechanical interfaces 14, 20 of the exchangeable rechargeable battery pack 10 or charging device 16 do not extend in a direction perpendicular to gravity so that, if the wireless interface 52 is arranged in a direction parallel to the electromechanical interface 40 of the adapter 38, there would be a risk of slipping of the attached energy receiver 48. It is likewise conceivable that the wireless interface 52 of the adapter 38 be adjustable in terms of its angle to the electromechanical interface 40 by the operator, e.g. by a hinge (not shown). In this case, at least the primary coil 54 must be a part of the foldable wireless interface 52.

In order to be able to charge an exchangeable rechargeable battery pack 10 connected to the mechanical interface 40 by means of the adapter 38 via its wireless interface 52, energy can alternatively also be transmitted in the opposite direction from the wireless interface 52 to the electromechanical interface 40. In this case, instead of the wireless energy receiver 48, a charging device operating in a wireless manner (not shown) is used as the energy source.

The adapter 38 features a very compact design. For example, its height extension 58 can be less than twice the height extension 60 of the electromechanical interface 40 in order to enable particular ease of stowing.

The adapter 38 comprises an indicator 62 for signaling the energy transport and/or a direction of the energy transport. A simple LED is sufficient to merely signal the energy transport, while either a multi-colored LED or two LEDs can be used for the directional indicator. Alternatively, an energy-saving LCD is also conceivable, which optionally provides additional information about the amount of energy transmitted, the duration of the energy transport, the voltage, and/or the current. An operator can therefore immediately detect whether energy is being transmitted and, optionally, which of the two charging partners is functioning as an energy source and which one is functioning as an energy receiver.

In addition to the electromechanical interface 40 for the exchangeable rechargeable battery pack 10, or rather for a charging device 16 suitable for charging the exchangeable rechargeable battery pack 10, as well as in addition to the wireless interface 52, the adapter 38 can have a further electromechanical interface 64, in particular a USB socket 66, for discharging and/or charging the exchangeable rechargeable battery pack 10 connected thereto.

In conclusion, it should be noted that the invention is not limited to the exemplary embodiment illustrated in FIG. 2. Therefore, the electromechanical interfaces 14, 20, 40 are to be understood by way of example. The same applies to the specified voltage and energy values.

1. An adapter for an exchangeable rechargeable battery pack of an electric device or for a charging device configured to charge the exchangeable rechargeable battery pack, the adapter comprising:
an electromechanical interface with electric contacts, via which the adapter is releasably connected to an electromechanical interface of the exchangeable rechargeable battery pack or of the charging device; and
a wireless interface configured to transmit energy provided by the exchangeable rechargeable battery pack or by the charging device to a wireless energy receiver.

2. The adapter according to claim 1, wherein the wireless interface has a primary coil.

3. The adapter according to claim 1, wherein the wireless interface operates in accordance with the Qi standard.

4. The adapter according to claim 1, wherein the wireless interface is arranged on a side of the adapter substantially opposite the electromechanical interface.

5. The adapter according to claim 1, wherein the adapter is configured such that an angle between the wireless interface and the electromechanical interface is adjustable by an operator.

6. The adapter according to claim 1, wherein the adapter is further configured to transmit energy from the wireless interface to the electromechanical interface.

7. The adapter according to claim 1, wherein the electromechanical interface of the adapter has a receptacle configured to lock with a locking device of the exchangeable rechargeable battery pack.

8. The adapter according to claim 1, wherein a height extension of the adapter is less than twice a height extension of the electromechanical interface.

9. The adapter according to claim 1, further comprising:
an indicator configured to signal an energy transport and/or a direction of the energy transport.

10. The adapter according to claim 1, further comprising:
a further electromechanical interface configured for discharging and/or charging the exchangeable rechargeable battery pack connected to the adapter.

11. The adapter according to claim 10, wherein the further electromechanical interface includes a USB socket.
